(19) United States
(12) Patent Application Publication
(10) Pub. No.: US 2020/0208465 A1
(43) Pub. Date: Jul. 2, 2020

(54) DOOR CONTROL DEVICE

(71) Applicant: NABTESCO CORPORATION, Tokyo (JP)

(72) Inventors: Shinji UEDA, Tokyo (JP); Yuki TAKAYAMA, Tokyo (JP); Hitoshi AKIYAMA, Tokyo (JP)

(21) Appl. No.: 16/722,723

(22) Filed: Dec. 20, 2019

(30) Foreign Application Priority Data
Dec. 26, 2018 (JP) 2018-243658

(51) Int. Cl. E06B 9/24; E06B 7/28

(52) U.S. Cl. CPC E06B 9/24; E06B 2009/2405; E06B 2009/2464; E06B 7/28

(57) ABSTRACT

A door control device includes an opening-closing control unit performing a control of opening and closing of a door, an acquisition unit acquiring state information about a state of the opening-closing control unit, a determination unit determining whether an external command that is related to opening or closing of the door and received from outside can be executed based on the state information acquired by the acquisition unit, and a notification control unit informing notification information for users of the door based on the state information through a notification unit when the external command cannot be executed.

### CROSS-REFERENCE TO RELATED APPLICATIONS

This application is based on and claims the benefit of priority from Japanese Patent Application Serial No. 2018-243658 (filed on Dec. 26, 2018), the contents of which are hereby incorporated by reference in its entirety.

### TECHNICAL FIELD

The present invention relates to a door control device.

### BACKGROUND

Japanese Laid-Open Patent Publication No. 2000-280896 (“the '896 Publication”) discloses a sunlight control device provided in a railway vehicle. The sunlight control device includes a liquid crystal panel attached to an inner surface of a window of the railway vehicle, and the liquid crystal panel has a light shielding function. In other words, the liquid crystal panel functions as a sunshade in the vehicle

The device described in the '896 Publication is provided on a window of the railway vehicle, so that the device is effective for persons located near the window. The liquid crystal panel of the device described in the '896 Publication has the light shielding function but does not have an information providing function. Here, there is a need for a device that can provide information about the exact state of a door.

### SUMMARY

In view of the foregoing circumstances, one object of the invention is to provide a door control device that is capable of providing information about the exact state of a door.

According to an aspect of the invention, a door control device includes an opening-closing control unit performing a control of opening and closing of a door, an acquisition unit acquiring state information about a state of the opening-closing control unit, a determination unit determining whether an external command that is related to opening or closing of the door and received from outside can be executed based on the state information acquired by the acquisition unit, and a notification control unit informing notification information for users of the door based on the state information through a notification unit when the external command cannot be executed.

In the door control device, when an external command relating to opening or closing of the door cannot be executed, the external command is not informed as the state of the door but notification is made based on the state information regarding the state of the opening-closing control unit. Therefore, the external command is not informed as the state of door but information about the exact state of the door is provided to users of the door.

In the door control device, the notification control unit may inform the notification information based on the external command through the notification unit, and the notification control unit may inform the notification information based on the state information when the external command cannot be executed.

In the door control device, the notification information can be informed based on an external command without confirming the state of the door so that the process of confirming the state information can be omitted. Further if the external command cannot be executed, the notification information is informed based on the state information so that it is possible to provide the information about the exact state of the door to the users of the door while reducing processes.

In the door control device, the notification control unit may inform the notification information indicating that an opening or closing function of the door is out of order regardless of the external command when the state information indicates that the opening-closing control unit is out of order. In this case, the notification information about the state of the door is prioritized over the external command so that the information about the exact state of the door can be provided.

In the door control device, the notification control unit may inform notification information indicating that other door should be used when the state information indicates that the opening-closing control unit is out of order.

Since the notification information for instructing passengers to use other door(s) is displayed on a malfunctioning door, the passengers can move to a properly functioning door and are able to get on or off the vehicle.

In the door control device, the state information may include one selected from the group consisting of information about a open or close state of the door, information about a door catching, information about a failure, and information about manual unlocking, or any combination thereof.

The door control device may further include a display unit projecting the notification information on the door or a periphery of the door. In this case, since the display unit projects information, the information can be displayed on the door or the periphery of the door without installing a display device therein.

The door may have a transmission unit that transmits light while reflecting a part of the light in a portion of the door where the display unit projects the notification information.

In this case, the notification information is viewable from the opposite side to the projection plane in which the information is projected by the projecting unit, in other words, from the outside of the railway vehicle. Therefore, information can be provided not only to passengers near the door inside the railway vehicle but also to passengers near the door outside the railway vehicle.

The door control device may further include a display unit that is disposed on the door or a periphery of the door and displays the notification information.

In this case, the display unit displays the notification information on the door or the periphery of the door to provide the information directly to users.

### BRIEF DESCRIPTION OF THE DRAWINGS

FIG. 1 is a schematic sectional view of a railway vehicle in a first embodiment of a door control device.

FIG. 2 is a block diagram showing a schematic configuration of the door control device of the first embodiment.

FIG. 3 illustrates an example of a display performed by the door control device of the first embodiment.

FIG. 4 illustrates an example of a display performed by the door control device of the first embodiment.

FIG. 5 is a sequence chart showing processes performed by the door control device of the first embodiment.

FIG. 6 is a sequence chart showing processes performed by the door control device of the first embodiment.

FIG. 7 shows an example of a display performed by the door control device of the first embodiment.

FIG. 8 is a sequence chart showing processes performed by the door control device of the first embodiment.

FIG. 9 is a schematic sectional view of a railway vehicle in a second embodiment of a door control device.

FIG. 10 is an example of a display performed by the door control device of the second embodiment.

FIG. 11 is a sequence chart showing processes performed by the door control device of the second embodiment.

FIG. 12 is a schematic sectional view of a railway vehicle in a modification example of the door control device.

FIG. 13 illustrates a display example of the door control device of the modification example.

### DESCRIPTION OF THE PREFERRED EMBODIMENTS

### First Embodiment

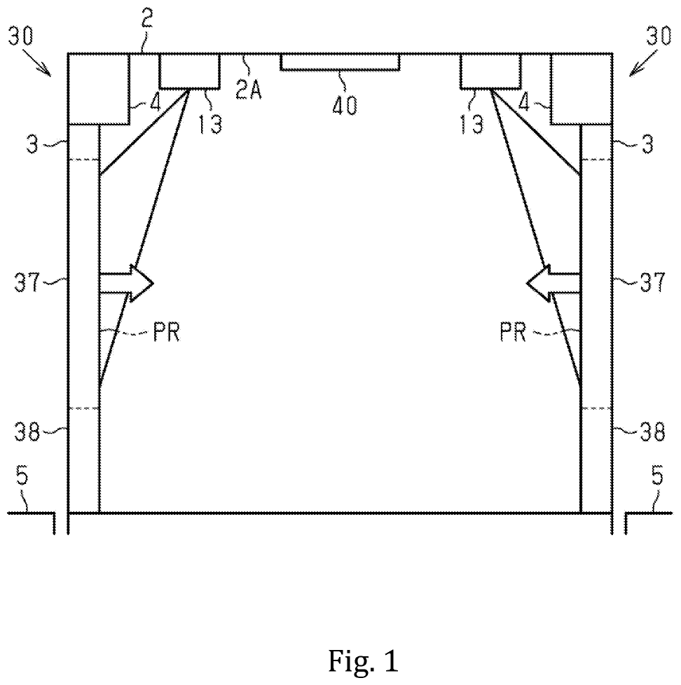

With reference to FIG. 1 to FIG. 8, a description is given of a first embodiment of a door control device.

As shown in FIG. 1, a railway vehicle 2 includes two or more doors 3. Each door 3 is a bi-parting door that opens and closes the entrance or exit for passengers. Each door 3 is opened and closed by a door device 30. The door device 30 is provided for each door 3.

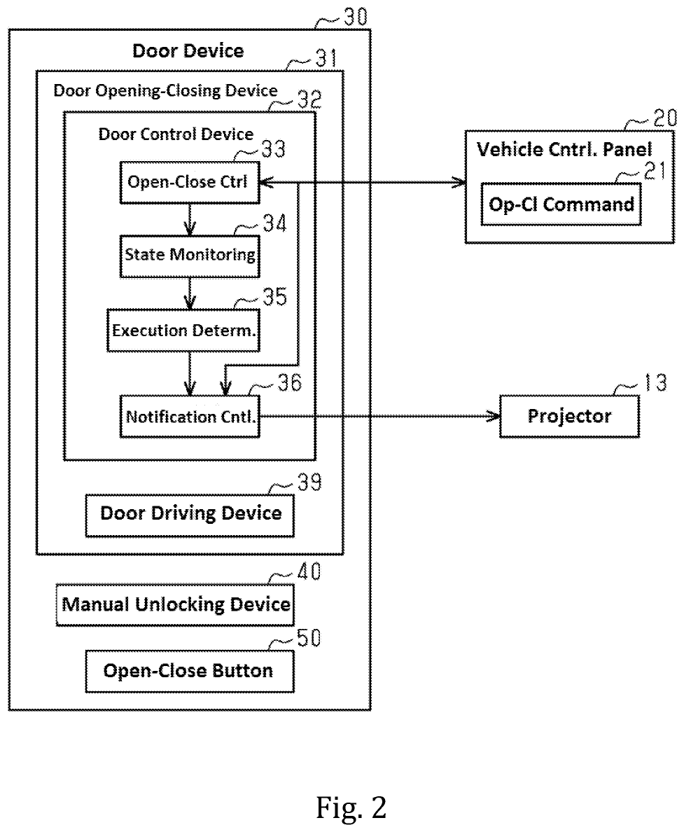

As shown in FIG. 2, the door device 30 includes a door opening-closing device 31 that opens and closes the door 3. The door opening-closing device 31 includes a door control device 32 that controls opening and closing of the door 3 and a door driving device 39 that drives the door 3 under the control of the door opening-closing device 31.

The door control device 32 includes an opening-closing control unit 33 that opens and closes the door 3 by controlling the door driving device 39. The door driving device 39 is, for example, a pneumatic cylinder. The door driving device 39 is not limited to a pneumatic cylinder but may be a driving device such as an electric motor.

The door device 30 includes a manual unlocking device 40 with which the door 3 can be manually unlocked. When the manual unlocking device 40 is operated, the door 3 is unlocked and the door 3 can be opened manually. The door device 30 includes an open-close button 50 that is operated by a passenger to open or close the door 3.

A vehicle control panel 20 is installed in a cab of the railway vehicle 2. The vehicle control panel 20 includes an open-close command unit 21 that commands a door control device 32 to open or close the door 3. When a driver operates the vehicle control panel 20, a door open command or a door close command is supplied from the open-close command unit 21 to the door control device 32. The door driving device 39 moves the door 3 to be opened when the door open command is supplied to the door control device 32, and the door driving device 39 moves the door 3 to be closed when the door close command is supplied to the door control device 32. The door open command and the door close command received by the door control device 32 from the vehicle control panel 20 correspond to external commands.

The door control device 32 in the door opening-closing device 31 is electrically coupled to the vehicle control panel 20 and is communicably interconnected thereto. The door control device 32 performs a door opening operation when the door open command is supplied from the vehicle control panel 20. The door control device 32 actuates the door driving device 39 to open the door 3. When the door open command is supplied from the vehicle control panel 20 to the door control device 32, the door control device 32 outputs a door open signal indicating that the door 3 is going to open. The door control device 32 actuates the door driving device 39 such that the door 3 is opened and outputs a failure signal when the door 3 is out of order.

For a railway vehicle that requires a passenger to operate the open-close button 50 to open or close the door 3, the vehicle control panel 20 outputs a semi-automatic command. When a semi-automatic command is supplied from the vehicle control panel 20 to the door opening-closing device 31, the door opening-closing device 31 outputs an unlock signal. When a passenger operates an open button of the open-close button 50, the door opening-closing device 31 performs the door opening operation. The door control device 32 actuates the door driving device 39 to open the door 3. When the door 3 is opened, the door opening-closing device 31 outputs a door opened signal indicating that the door 3 is open.

When a passenger operates a close button of the open-close button 50, the door opening-closing device 31 performs a door closing operation. The door control device 32 actuates the door driving device 39 to close the door 3. When the door 3 is closed, the door opening-closing device 31 stops supplying the door opened signal.

The door control device 32 includes a state monitoring unit 34 as an acquisition unit that acquires state information regarding the state of the opening-closing control unit 33. The state information includes, for example, information about an open or close state of the door 3, information about door catching in which an object or the like is caught in the door 3, information about a failure of the opening-closing control unit 33 or the door driving device 39, and information about whether manual unlocking has been performed.

The door control device 32 includes an execution determination unit 35 as a determination unit that determines whether the external command related to opening or closing of the door 3 received from the outside can be executed based on the state information acquired by the state monitoring unit 34. When the execution determination unit 35 determines that the external command cannot be executed, the execution determination unit 35 outputs failure information indicating that the external command cannot be executed to a notification control unit 36.

The door control device 32 includes the notification control unit 36 that informs the state of the door 3. The notification control unit 36 receives an external command related to opening or closing of the door 3 from the outside. That is, the door control device 32 acquires the external command from the vehicle control panel 20 at the opening-closing control unit 33 and the notification control unit 36.

The notification control unit 36 informs notification information for users of the door 3 based on the external command. Specifically, the notification control unit 36 informs notification information indicating that the door 3 is going to open in response to reception of the door open command. When the notification control unit 36 received the door close command, the notification control unit 36 informs notification information indicating that the door 3 is going to close.

The notification control unit 36 informs notification information based on the state information when the execution determination unit 35 determines that the external command cannot be executed. Specifically the notification control unit 36 informs that the opening-closing function of the door 3 is not working. When the external command cannot be executed after informing the notification information based on the external command, the notification control unit 36 informs notification information based on the state information. In addition, when the computing capability of the door control device 32 is high and it is determined that the external command cannot be executed before the notification information is informed based on the external command, the notification information is informed not based on the external command but based on the state information.

When the execution determination unit 35 determines that the opening-closing control unit 33 is out of order based on the state information, the notification control unit 36 informs the notification information indicating that the opening or closing function of the door 3 is not working regardless of the external command. Instead of informing the notification information triggered by the reception of the external command, the notification control unit 36 informs the notification information indicating that the opening and closing function of the door 3 is not working in response to the determination by the execution determination unit 35 that the opening-closing control unit 33 is out of order based on the state information acquired by the state monitoring unit 34. Then, the notification control unit 36 informs passengers that they should use other door 3 when the opening-closing control unit 33 is out of order based on the state information.

The notification control unit 36 inform the notification information through a projector 13 that serves as a notification unit. The projector 13 projects the notification information on the door 3 using an image and/or video. The projector 13 is provided for each door 3. The notification control unit 36 selects notification information that is to be projected on the projector 13 from among information acquired by the state monitoring unit 34, then selects an image(s) and/or video(s) prepared in advance based on the selected notification information, and transmits it (them) to the projector 13. Alternatively the notification control unit 36 may generate an image or a video based on the selected notification information selected before transmitting it to the projector 13.

As shown in FIG. 1, the projector 13 is provided on a ceiling 2A of the railway vehicle 2. The projector 13 is disposed near the door 3 to be projected. The projector 13 is preferably a short focus projector capable of close-up projection.

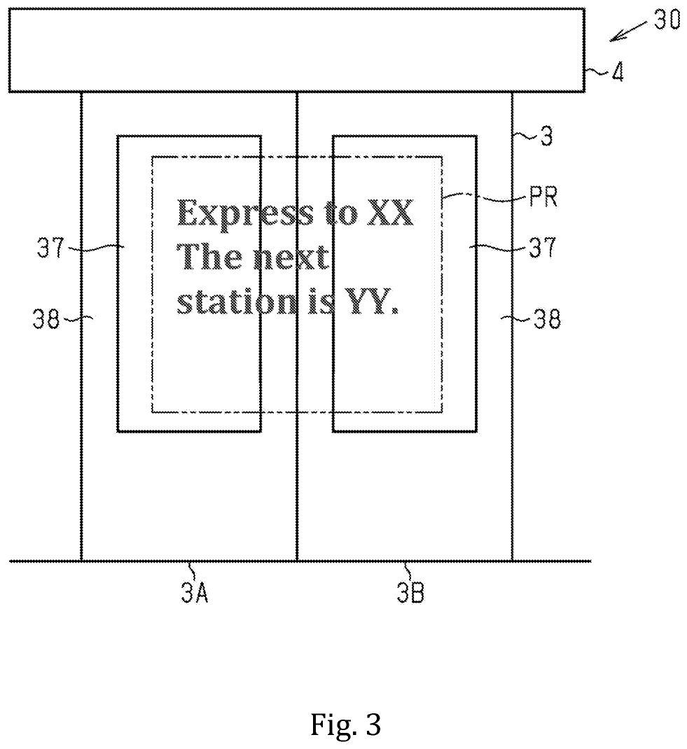

As shown in FIGS. 1 and 3, the door 3 includes the first door leaf 3A on the left side in FIG. 3 and the second door leaf 3B on the right side in FIG. 3. A transparent window 37 is provided at the center of each of the first door leaf 3A and the second door leaf 3B. The window 37 is formed of an instantaneous light control material that becomes opaque when a voltage is applied thereto. The instantaneous light control material is, for example, a transparent member to which an instantaneous light control film is attached, an instantaneous light control glass, or the like. As for the surface of a door portion 38 that is a portion of the door 3 other than the window 37, it is preferable that the whole surface is colored with the same plain color without any pattern. A projection range PR of the projector 13 is a range included in the vertical direction of the window 37, and the range includes the window 37 of the first door leaf 3A, the window 37 of the second door leaf 3B, and the door portion 38 between the windows 37. The instantaneous light control material used for the window 37 may be provided on the entire surface of the window 37 or may be provided on a part of the window portion 37 when the projection range PR is small. The white arrow in FIG. 1 indicates a recognition direction in which a projected image can be recognized by viewers.

The notification control unit 36 displays an in-vehicle display as the notification information for passengers who are on the railway vehicle 2. That is, an image(s) and/or video(s) projected on the door 3 is a display of guidance directed to passengers inside the railway vehicle 2. The in-vehicle display includes the state of the door 3, a destination guidance, and the like.

For example, as an example of the in-vehicle display when the door 3 is going to open, the notification control unit 36 displays an image (a door open display) such as “the door on this side opens” indicating that the door 3 is going to open. In addition, as an example of the in-vehicle display when the door 3 detects a door catching, the notification control unit 36 displays an image (a door catching display) such as “something is caught by the door” indicating the door catching. In addition, as an example of the in-vehicle display, the notification control unit 36 displays an image (a guidance display) such as “the opposite door 3 opens” when the door 3 closes and the opposite door 3 is going to open.

FIG. 3 shows a destination guidance display as an example of the in-vehicle display performed by the notification control unit 36. At the center of the door 3, an image “Express to XX, the next station is YY” is projected by the projector 13 as the destination guidance display.

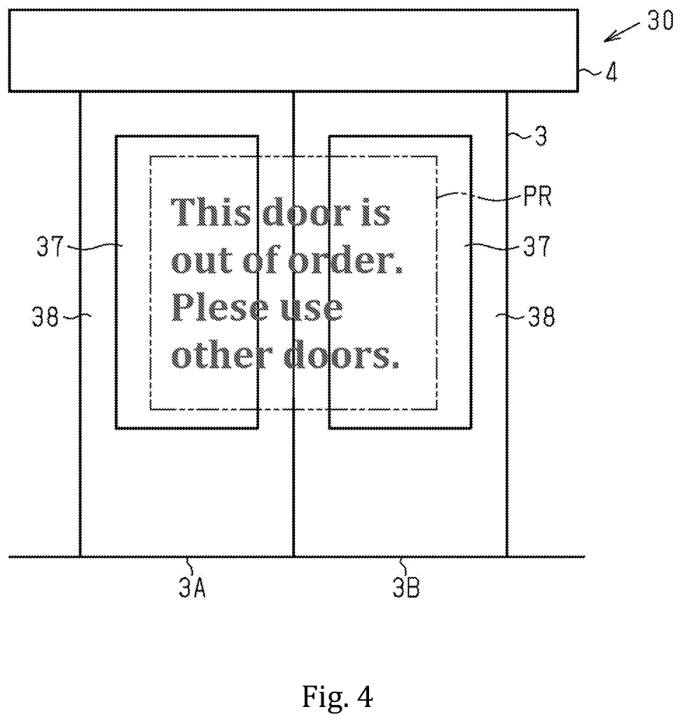

In FIG. 4, as an example of the in-vehicle display performed by the notification control unit 36, a door failure display for informing passengers that other door 3 should be used is shown. An image of “This door is out of order, please use other doors” is projected at the center of the door 3 by the projector 13 as the door failure display.

When the state monitoring unit 34 acquired the door close command, the notification control unit 36 performs an in-vehicle display. When the state monitoring unit 34 acquired the door open command indicating that the door 3 is going to open, the notification control unit 36 stops displaying the in-vehicle display. When the state monitoring unit 34 acquired failure information as the state information, the notification control unit 36 displays the failure display.

When the door opening-closing device 31 drives the door after a predetermined time has elapsed following the door open command supplied from the opening-closing command unit 21 of the vehicle control panel 20, the notification control unit 36 displays a door opening operation display for a predetermined time. When the state monitoring unit 34 acquired the door open command as the state information, the notification control unit 36 displays the door opening operation indicating that the door 3 is going to open for a predetermined time after the state monitoring unit 34 acquired the door open command.

For the railway vehicle that requires a passenger to operate the open-close button 50 to open or close the door 3, the notification control unit 36 displays an open button guidance display when the state monitoring unit 34 acquired a semi-automatic command. When the state monitoring unit 34 acquired open button operated information as the state information, the notification control unit 36 stops displaying the open button guidance display.

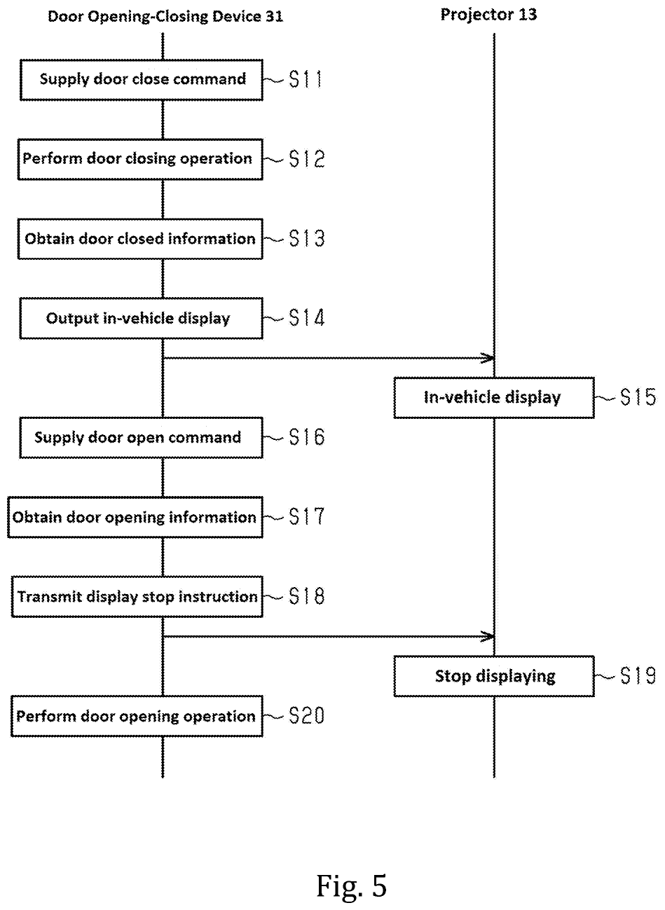

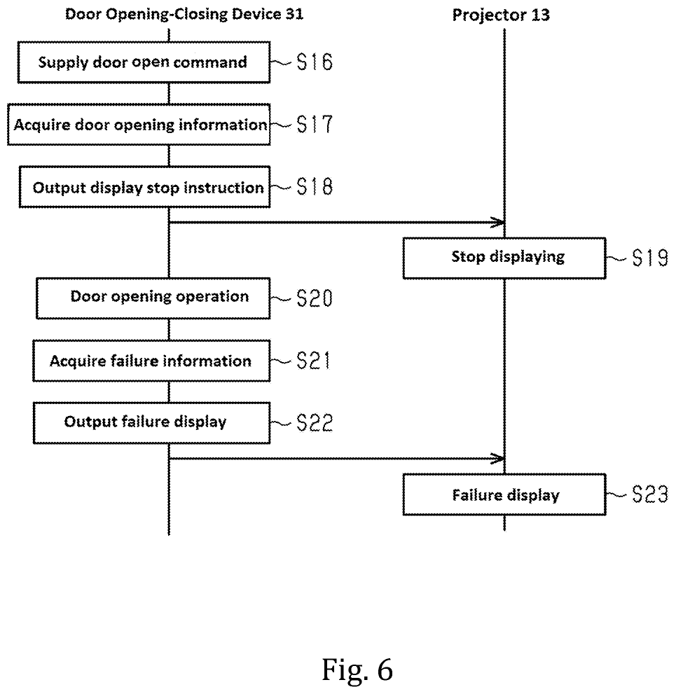

A display process performed by the notification control unit 36 will now be described with reference to FIGS. 5 and 6. Here, the display process in an operation of closing the opened door 3 and opening the closed door 3 will be described.

As shown in FIG. 5, when a door close command is supplied from the vehicle control panel 20 (step S11), the door opening-closing device 31 first performs a door closing operation (step S12). That is, the opening-closing control unit 33 of the door control device 32 causes the door drive device 39 to close the door 3.

When the door 3 is closed, the state monitoring unit 34 acquires door closed information (step S13).

When the state monitoring unit 34 acquired the door closed information as the state information, the notification control unit 36 outputs, to the projector 13, an in-vehicle display as the notification information to be displayed on the door 3 (step S14). Then, the projector 13 performs the in-vehicle display when the in-vehicle display is supplied from the notification control unit 36 (step S15). The notification control unit 36 displays, for example, the destination guidance display shown in FIG. 3 as the in-vehicle display. A passenger who has boarded the railway vehicle 2 is able to confirm the destination of the railway vehicle 2 in which the passenger is on board by viewing the destination guidance display projected on the door 3.

Note that the notification control unit 36 may switch the in-vehicle display between the destination guidance display and advertisement while the railway vehicle 2 is traveling, or display such information on the same screen of the door 3 in corresponding sections of the screen. In this way, a wide display region can be ensured, a large display can be realized, and a lot of information can be displayed therein.

When the door open command is supplied from the vehicle control panel 20 to the door opening-closing device 31 (step S16), the state monitoring unit 34 acquires door opening information indicating that the door 3 is going to open (step S17). When the state monitoring unit 34 acquired the door opening information as the state information, the notification control unit 36 outputs, to the projector 13, a display stop instruction to stop displaying on the door 3 (step S18). The projector 13 stops displaying the in-vehicle display when the display stop instruction is supplied from the notification control unit 36 (step S19). Passengers may feel uncomfortable with a dazzling light of the projector if projection is performed on the door 3 when they try to get on the railway vehicle 2, so that the projection may be stopped just before the door 3 opens in order to avoid affecting the passengers.

When the door open command is supplied from the vehicle control panel 20 (step S16), the door opening-closing device 31 performs a door opening operation (step S20). That is, the door control device 32 actuates the door driving device 39 to open the door 3.

A display process performed by the notification control unit 36 when a failure occurs in the door 3 during the opening operation of the door 3 will be now described.

As shown in FIG. 6, when the door control device 32 causes the door driving device 39 to open the door (step S20) but the door 3 does not move to the fully open state and fails, the state monitoring unit 34 acquires the failure information as the state information (step S21). That is, the execution determination unit 35 determines that the external command cannot be executed and outputs the failure information indicating that the external command cannot be executed to the notification control unit 36. When the state monitoring unit 34 acquired the failure information as the state information, the notification control unit 36 outputs, to the projector 13, a failure display including the failure information as the notification information (step S22).

The notification control unit 36 performs the failure display (step S23). For example, the notification control unit 36 displays the failure indication shown in FIG. 4 as the failure display. Passengers who try to get off the railway vehicle 2 are able to know that the nearest door 3 is not available by looking at the failure display projected on the door 3, and move to other door(s) 3.

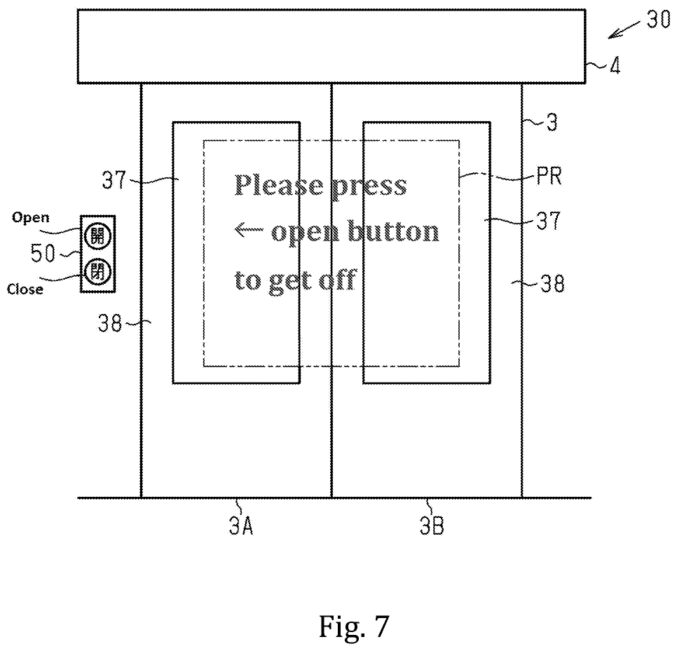

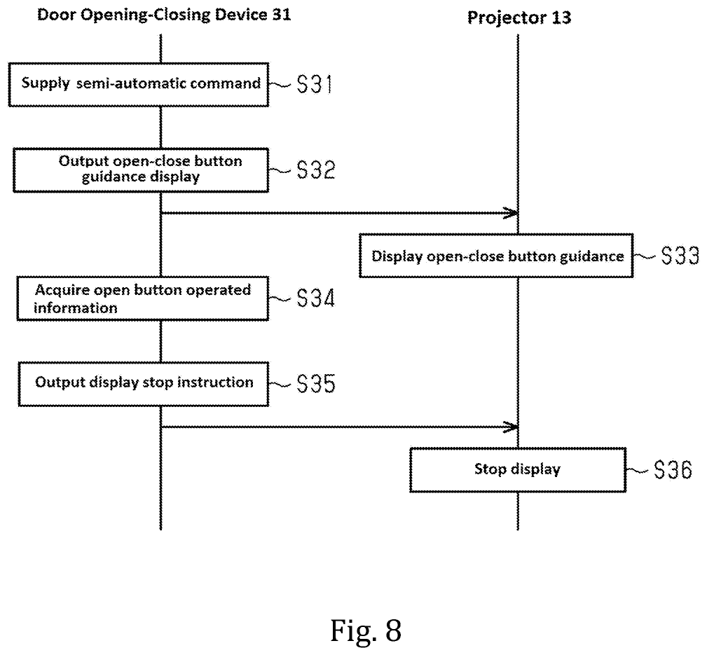

A display process performed in a railway vehicle that requires a passenger to operate the open-close button to open or close the door 3 will be described with reference to FIGS. 7 and 8.

As shown in FIG. 7, the door 3 of some railway vehicle 2 is first unlocked when arrived at the station platform 5, then the open-close button 50 installed by the door 3 is operated to open or close the door 3. In such a railway vehicle 2, a passenger who wishes to get off the vehicle may not be aware that he/she has to operate the open-close button 50. For this reason, the notification control unit 36 performs an open button guidance display so as to prompt the passenger to operate the open-close button 50 when the railway vehicle arrives at the platform 5 of the station. In the open button guidance display, an image of “Please press the open button to get off” is projected on the door 3.

In the railway vehicle 2 shown in FIG. 8, the door 3 is closed and the in-vehicle display is displayed. When the semi-automatic command is supplied from the vehicle control panel 20 (step S31), the notification control unit 36 outputs an open-close button guidance display to the projector 13 (step S32). The projector 13 displays the open-close button guidance display (step S33).

At this time, if the door 3 is out of order, for example, the notification control unit 36 outputs the failure display including failure information to the projector 13. In this case, the failure information acquired by the state monitoring unit 34 is prioritized over the semi-automatic command of the vehicle control panel 20, and the notification control unit 36 causes the projector 13 to display the failure display.

When the passenger operated the open button, the state monitoring unit 34 of the door opening-closing device 31 acquires the open button operated information (step S34). When the state monitoring unit 34 received the open button operated information as the state information, the notification control unit 36 outputs a display stop instruction to stop displaying the open button guidance display (step S35). Then, the projector 13 stops displaying the open button guidance display when the display stop instruction is supplied from the notification control unit 36 (step S36). When a passenger operated the open button, the door opening-closing device 31 performs the door opening operation. That is, the door control device 32 actuates the door driving device 39 to open the door 3.

The notification control unit 36 displays information about the state of the door 3 based on the state information of the door 3 acquired by the state monitoring unit 34 of the door opening-closing device 31. In particular, when the door 3 is out of order, the door 3 (the door opening-closing device 31) itself directly acquires information about the door 3 such as detection of a door catching without involvement from the vehicle control panel 20. Therefore it is possible to immediately display the information about the door 3 (the door opening-closing device 31) on the door 3.

As described above, according to the embodiment, the following advantageous effects can be obtained.

(1) When an external command relating to opening or closing of the door 3 cannot be executed, the external command is not informed as the state of the door 3 but notification is made based on the state information regarding the state of the opening-closing control unit 33. Therefore, the external command is not informed as the state of door 3 but information about the exact state of the door 3 is provided to users of the door 3.

(2) The notification information can be informed based on an external command without confirming the state of the door 3 so that the process of confirming the state information can be omitted. Further if the external command cannot be executed, the notification information is informed based on the state information so that it is possible to provide the information about the exact state of the door 3 to the users of the door 3 while reducing processes.

(3) Since it is notified that the door 3 is out of order and cannot be opened or closed regardless of an external command from the vehicle control panel 20 or the like, it is possible to promptly let passengers know about the opening or closing failure of the door 3.

(4) Since the notification information for instructing passengers to use other door(s) 3 is displayed on a malfunctioning door 3, the passengers can move to a properly functioning door 3 and are able to get off the vehicle therefrom.

(5) Since the display unit is the projector 13 that projects information, the information can be displayed on the door 3 without installing a display device on the door 3.

(6) Destination information and the state information about the door 3 can be provided on the same display device.

### Second Embodiment

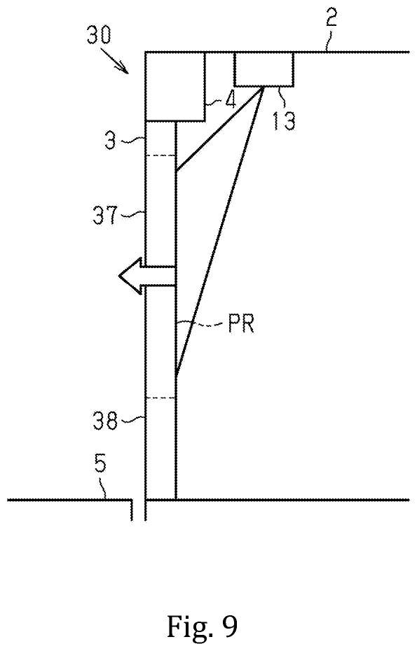

With reference to FIG. 9 to FIG. 11, a description is given of a second embodiment of the door control device. The door control device of this embodiment is different from the first embodiment in that information is provided to passengers situated outside the railway vehicle. The following description will be focused on differences from the first embodiment.

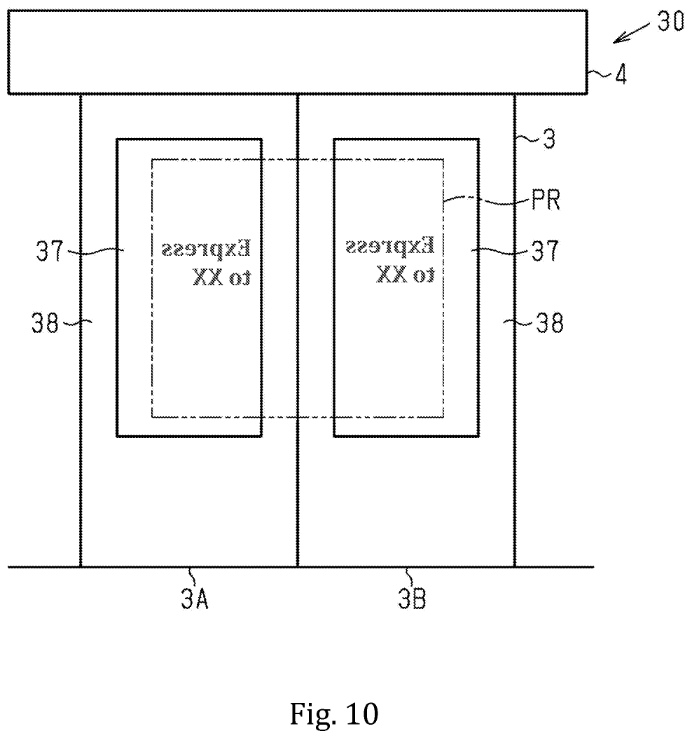

As shown in FIG. 9 and FIG. 10, the notification control unit 36 perform an out-vehicle display in order to provide information to passengers on the platform 5 outside the railway vehicle 2. That is, the projector 13 projects an inverted image(s) and/or video(s) on the door 3. Since the in-vehicle display targeted for passengers on the railway vehicle 2 is difficult to read for passengers on the platform 5, an inverted image(s) and/or video(s) adequate for the passengers on the platform 5 is displayed on the door 3 as the out-vehicle display. The white arrow in FIG. 9 indicates a recognition direction in which a projected image can be recognized by viewers.

The projection range PR of the projector 13 is a range including the window 37 of the first door leaf 3A, the window 37 of the second door leaf 3B, and the door portion 38 between the windows 37. However, an image(s) and/or video(s) is projected only on the windows 37. Further, the in-vehicle display may be projected on the door portion 38 between the two windows 37.

The notification control unit 36 may store in advance the inverted image(s) and/or video(s) as the out-vehicle display, or may invert a stored image(s) and/or video(s) when the image(s) and/or video(s) is outputted to the projector 13.

The notification control unit 36 switches between the in-vehicle display and the out-vehicle display depending on the situation of the railway vehicle 2. For example, only the in-vehicle display may be performed while the vehicle is traveling, and the in-vehicle display or the outside-vehicle display or both may be performed while the vehicle is stopped.

When the railway vehicle approaches a station, the vehicle control panel 20 outputs a station approaching signal to the door control device 32.

When the station approaching signal is supplied from the vehicle control panel 20 to the notification control unit 36, the notification control unit 36 outputs, to the projector 13, an out-vehicle display including information to be displayed outside the door 3. Then, the projector 13 performs the in-vehicle display. The notification control unit 36 switches the display for passengers inside the railway vehicle 2 to the display for passengers on the platform 5 outside the railway vehicle 2.

FIG. 10 illustrates a destination guidance display as an example of the out-vehicle display performed by the notification control unit 36. On each window 37 of the door 3, an image “Express to XX” is projected by the projector 13 as the destination guidance display.

The door 3 includes windows 37 as a transmission unit that transmits light while reflecting a part of the light in a portion of the door 3 where the projector 13 projects a display. The window 37 of the door 3 is made of an instantaneous light control material that can be switched between opaque and translucent by applying a voltage. The instantaneous light control material is, for example, a transparent member to which an instantaneous light control film is attached, an instantaneous light control glass, or the like. The instantaneous light control material of the window 37 becomes opaque by applying a voltage when the in-vehicle display is performed, and becomes translucent by applying a voltage when the out-vehicle display is performed. When the window 37 is translucent, light transmits through the window while a part of light is reflected, so that the window 37 functions as the transmission unit.

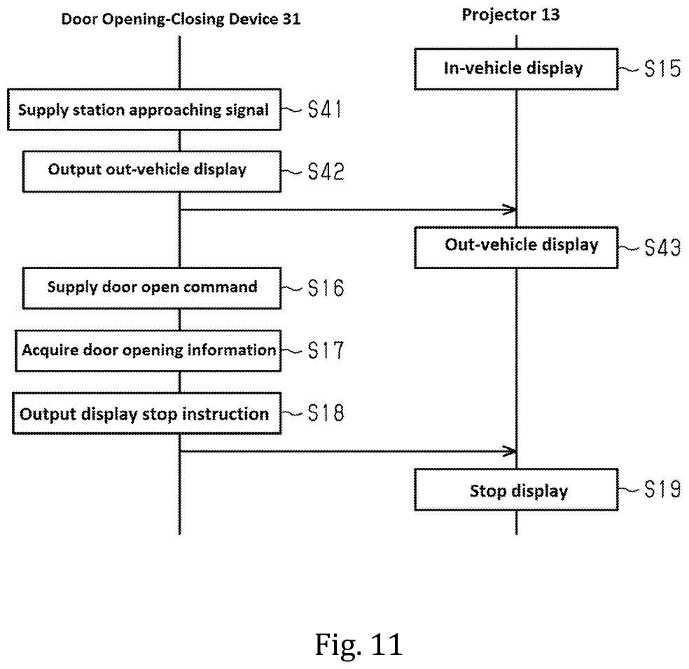

As shown in FIG. 11, the notification control unit 36 performs the in-vehicle display while the vehicle is traveling (step S15). The notification control unit 36 displays, for example, the destination guidance display shown in FIG. 3 as the in-vehicle display.

Subsequently, when the station approaching signal is supplied from the vehicle control panel 20 (step S41), the notification control unit 36 outputs the out-vehicle display to the projector 13 (step S42). In other words, the notification control unit 36 switches the display for passengers inside the railway vehicle 2 to the display for passengers on the platform 5 outside the railway vehicle 2. Then, the projector 13 performs the out-vehicle display (step S43).

When the door open command indicating that the door 3 is to open is supplied from the vehicle control panel 20 to the door opening-closing device 31 (step S16), the state monitoring unit 34 acquires the door opening information indicating that the door 3 is going to open (step S17). When the door opening information is received, the notification control unit 36 outputs, to the projector 13, the display stop instruction to stop displaying on the door 3 (step S18). Then, the projector 13 stops displaying the out-vehicle display when the display stop instruction is supplied from the notification control unit 36 (step S19). Passengers may feel uncomfortable with a dazzling light of the projector if projection is performed on the door 3 when they try to get on the railway vehicle 2, so that the projection may be stopped just before the door 3 opens in order to avoid affecting the passengers.

When the door open command is supplied from the vehicle control panel 20 (step S16), the door opening-closing device 31 performs a door opening operation (step S20). That is, the door control device 32 actuates the door driving device 39 to open the door 3.

The notification control unit 36 projects an inverted image(s) and/or video(s) as the out-vehicle display on the window 37 of the door 3. Therefore, information can be provided also to passengers outside the railway vehicle 2.

As described above, according to the above embodiment, the following effects can be obtained in addition to the effects (1) to (7) of the first embodiment.

(8) It is possible for passengers outside of the railway vehicle 2 to see the notification information by the projector 13. In other words, the notification information is viewable from the opposite side to the projection plane in which the information is projected. Therefore, information can be provided not only to passengers near the door 3 inside the railway vehicle 2 but also to passengers near the door 3 outside the railway vehicle 2.

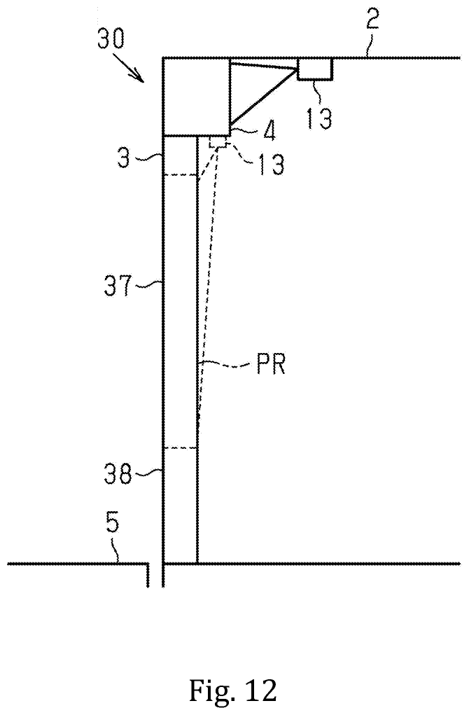

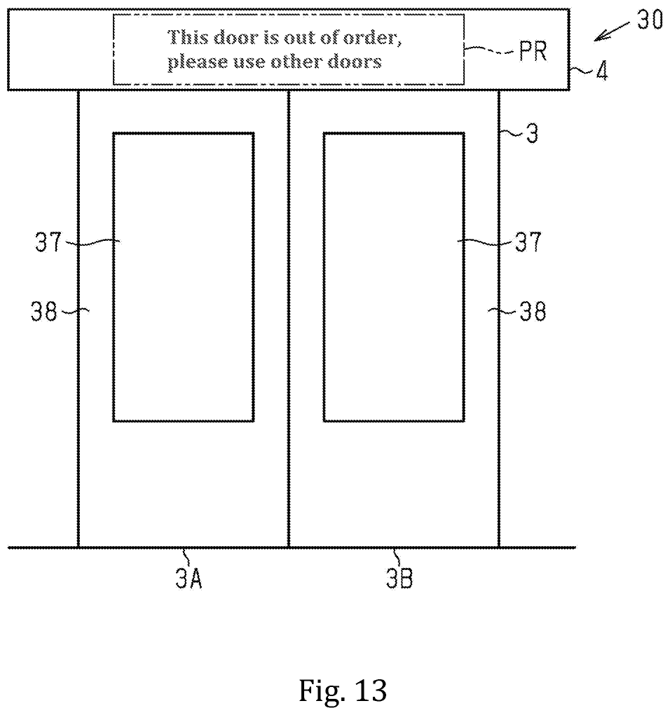

The foregoing embodiment can also be appropriately modified as described below.
In each of the above-described embodiments, the degree of danger may be displayed in conjunction with the opening or closing operation of the door 3 to prevent passengers from being caught by the door and dragged by the moving railway vehicle. Further, announcement of door opening or closing may be displayed in conjunction with the opening or closing operation of the door 3 to reduce the time taken for passengers to get on or off the railway vehicle and thereby a delay of the train can be prevented. The display of the degree of danger, the door opening or closing announcement and the like is realized by directly acquiring the information about the opening or closing operation of the door 3 without the vehicle control panel 20. Therefore it is possible to immediately display the information about the door 3 (the door opening-closing device 31) on the door 3.
In each of the above embodiments, the state of the door 3 is displayed on the door 3. Instead or in addition, the occupancy of the vehicle may be displayed on the door 3. Furthermore, the occupancy of other vehicle(s) of the train may be also displayed on the door 3. When the vehicle occupancy by passengers is displayed, the notification control unit 36 is equipped with a sensor or camera that detects passengers passing through the entrance or exit of the vehicle to count the number of passengers passing through the entrance or exit to calculate the occupancy. Moreover, the vehicle body of the rail vehicle 2 may be equipped with a weight sensor, and the notification control unit 36 may estimate the occupancy from a detected weight.
In each of the above embodiments, an evacuation guidance display for instructing passengers to evacuate from the vehicle may be displayed on the door 3 in an emergency such as an emergency stop of the railway vehicle 2. For example, as an example of the evacuation guidance display, the projector 13 projects an image such as “←Exit is over there” or “You cannot exit from this door.”
In addition, the notification control unit 36 may include a battery and may continue to display information such as the evacuation guidance display until a battery runs out in the event of a power failure or the like.
In each of the above embodiments, the projector 13 is installed on the ceiling 2A of the railway vehicle 2. However, when the projector is a single-focus projector, the projector 13 may be installed in a lower portion of a transom 4 as shown by the broken line in FIG. 12.
In each of the above embodiments, the door 3 is provided with the window 37. Alternatively the entire surface of the door 3 may be the door portion 38 without the window 37. In such a case, it is not necessary to use the instantaneous light control material for the window 37.
In each of the above embodiments, an image and/or video indicating the state of the door 3 is projected onto the door 3. Alternatively an image and/or video may be projected on the periphery of the door 3. The state of the door 3 may be displayed on both the door 3 and the periphery of the door 3. For example, as shown in FIGS. 12 and 13, an image or a video indicating the state of the door 3 may be projected on the transom 4 located above the door 3. In this case, it is preferable that the surface of the transom 4 have no patterns. The projector 13 is installed on the ceiling 2A. The door failure display of “This door is out of order, please use other doors” is projected on the surface of the transom 4 as an example of the in-vehicle display. According to such a configuration, passengers are less likely to enter the projection range PR of the projector 13, and an image and/or video can be appropriately projected onto the projection target.
Alternatively or in addition, it is also possible to project an image and video indicating the state of the door 3 on a door frame and the like of the door 3 that is situated lateral to the door 3. In this case, it is preferable that the surface of the door frame and the like have no patterns.
Moreover, an image and/or video indicating the state of the door 3 may be projected on the ceiling 2A or floor of the rail vehicle 2. In this case, it is preferable that the surface of the ceiling 2A or floor of the rail vehicle 2 have no patterns.
In each of the above embodiments, the projector 13 is employed as the display unit and the projector 13 can take any projection method.
In each of the above embodiments, the projector 13 is used as the display unit. Alternatively, the display unit may be a display device that performs direct display. In this case, the display device itself is installed at the location where an image or the like is projected by the projector 13.
In the above embodiments, the door 3 is a bi-parting door. Alternatively it may be a single sliding door.
In the above embodiments, the notification control unit 36 may display only the state information of the door 3.

What is claimed is:

1. A door control device, comprising:
an opening-closing control unit performing a control of opening and closing of a door;
an acquisition unit acquiring state information about a state of the opening-closing control unit;
a determination unit determining whether an external command received from outside can be executed based on the state information acquired by the acquisition unit, the external command being related to opening or closing of the door; and
a notification control unit informing notification information for users of the door based on the state information through a notification unit when the external command cannot be executed.

2. The door control device of claim 1, wherein the notification control unit informs the notification information based on the external command through the notification unit, and the notification control unit informs the notification information based on the state information through the notification unit when the external command cannot be executed.

3. The door control device of claim 1, wherein the notification control unit informs the notification information indicating that an opening or closing function of the door is out of order regardless of the external command when the state information indicates that the opening-closing control unit is out of order.

4. The door control device of claim 1, wherein the notification control unit informs the notification information indicating that other door should be used when the state information indicates that the opening-closing control unit is out of order.

5. The door control device of claim 1, wherein the state information includes one selected from the group consisting of information about a open or close state of the door, information about a door catching, information about a failure, and information about manual unlocking, or any combination thereof.

6. The door control device of claim 1, further comprising:
a display unit projecting the notification information on the door or a periphery of the door.

7. The door control device of claim 6, wherein the door has a transmission unit that transmits light while reflecting a part of the light in a portion of the door where the display unit projects the notification information.

8. The door control device of claim 1, further comprising:
a display unit that is disposed on the door or a periphery of the door and displays the notification information.
